(19) United States
(12) Patent Application Publication
(10) Pub. No.: US 2006/0288588 A1
(43) Pub. Date: Dec. 28, 2006

(54) GARDEN TOOL

(76) Inventor: Frank Morabito, Winnetka, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/307,939

(22) Filed: Feb. 28, 2006

Related U.S. Application Data
(60) Provisional application No. 60/693,211, filed on Jun. 22, 2005.

(51) Int. Cl. B26B 29/00

(52) U.S. Cl. 30/294

(57) ABSTRACT

A multi-purpose, hand-held garden tool includes a single curved blade having an end connected to an elongated handle. A series of serrations are formed on a side edge of the blade adjacent to a free end thereof. Typically, the free end is tapered to a point, or includes two prongs forming a V-shaped notch. At least one notch is formed in a side edge of the blade, which is sized and configured to sever off-shoots of plant life.

### BACKGROUND OF THE INVENTION

The present invention generally relates to garden tools. More particularly, the present invention relates to a garden tool which is designed and configured so as to have a plurality of functions and purposes.

There are known many mechanisms for removing weeds and the like. For example, Rota tillers have machine-operated tines for cultivating the soil and turning over weeds. There also exist other hand-operated means, whereby the tool includes rotatable and movable elements to achieve essentially the same purpose. However, these devices have several drawbacks. Chiefly among those is the cost and complicated nature of the devices. Secondly, these devices cannot often be used in close proximity to plants as they could damage the plants. Moreover, these devices are very limited in their operation as they do not serve as sickles to cut weeds, nor can they remove suckles and branches from bushes and trees.

Sickles are known for use in cutting long grass and weeds. The sickles are moved in a lateral side-to-side sweeping motion and have a blade at the end of an elongated handle for cutting such grass and weeds. U.S. Pat. No. 2,718,700 to Stecher, discloses an improvement on the traditional sickle. However, such sickles are not capable of performing ordinary gardening chores, such as removing weeds around delicate plants, removing branches and suckles from trees and bushes, etc.

Various tools and devices have been created for pulling weeds one at a time. For example, U.S. Pat. No. 2,019,357 to Oestreich, U.S. Pat. No. 3,293,674 to Sapia, U.S. Pat. No. 3,865,348 to Close, and U.S. Pat. No. 5,383,523 to Stamp all deal with weeding tools wherein the weed is pulled along with its roots, one at a time. Such tools serve adequately well to remove a weed at a time by the roots, but are limited otherwise.

There are yet other devices and tools for weeding around delicate plants and the like, typically referred to as weed hooks or garden crooks. Illustrative of such tools are U.S. Pat. No. 1,224,957 to Robinson, U.S. Pat. No. 4,177,864 to Donnini, and U.S. Pat. No. 6,360,826 to Barber. However, these devices are limited in pulling out weeds and cultivating the ground immediately adjacent to the plant. These devices typically have a pointed or V-shaped end so as to break up the ground and remove the plants. They also include a curved end for reaching around the plant and scraping the ground. However, these devices are also limited in their use as they only serve these purposes, and cannot function in a manner so as to remove suckers, tree branches, or otherwise cut limbs and garden necessities.

U.S. Pat. No. 5,377,374 to Green discloses a turf and garden tool which is designed to serve multiple purposes. The tool includes a footstep and a root trap tool for digging out and pulling weeds one at a time. The tool also includes a sharp upper edge for severing branches of small plants and the like. However, the tool does not have a crook shape, nor does it include other sharp edges to serve as a sickle or weed hook and crook to scrape the ground so as to remove grasses and weeds in a fast manner.

Accordingly, there is a continuing need for a garden tool which is capable of not only removing weeds, but also scraping and cultivating the ground, severing suckers and branches of plants, bushes and small trees and the like. The tool should also be capable of performing other tasks, such as serving as a utility knife so as to cut other objects, such as twine and the like. The present invention fulfills these needs and provides other related advantages.

### SUMMARY OF THE INVENTION

The present invention resides in a multi-purpose hand-held gardening tool. The gardening tool of the present invention is specifically designed so as to be configured to perform a plurality of gardening functions, such as digging into the ground to cultivate around plants and remove weeds, scrape the ground to remove low lying grasses and weeds, quickly and easily remove offshoots or suckers from bushes, trees and vines, as well as serve as a gardener's knife to cut twine, etc.

The garden tool of the present invention generally comprises an elongated handle having a single blade connected to an end thereof. The handle may be as short as one foot in length, to six feet in length so as to be used by a gardener when standing upright.

The single blade is curved so as to have a generally U-shaped configuration. In a particularly preferred embodiment, first and second side edges of the blade are generally parallel to one another, such that the blade is generally of constant width.

The free end of the blade is pointed, such as being tapered to a point. In a particularly preferred embodiment, the free end includes a notch formed therein which is generally V-shaped, and defined by two pointed prongs. The notch may include sharpened edges.

A series of barbs or serrations are formed on either the first and/or second side edge of the blade adjacent to the free end thereof. Preferably, at least a portion of an edge of the blade is sharpened. Portions of opposite edges of the blade may be sharpened.

At least one notch is formed in the first or second edge, so as to be generally directed towards the handle. The notch is sized and configured to sever off-shoots of plant life. Typically, at least one notch defining an edge generally directed away from the handle is also formed in the blade for severing off-shoots of plant life. Edges defined by these notches are preferably sharpened. An exterior end of the side edge notches also typically define a sharp point.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a tool embodying the present invention.

FIG. 2 is a partially fragmented and enlarged view of the tool of FIG. 1.

FIG. 3 is a partially fragmented and enlarged view of another tool embodying the present invention.

FIG. 4 is a side perspective view of a tool of the present invention.

FIG. 5 is a side elevational view of the tool of FIG. 4; and

FIG. 6 is a cross-sectional view taken generally along lines 6-6 of FIG. 5, illustrating a blade attached to a handle of the tool.

### DETAILED DESCRIPTION OF THE PREFERRED EMBODIMENTS

As shown in the accompanying drawings, for purposes of illustration, the present invention resides in a multi-purpose, hand-held garden tool, generally referred to by reference numbers 10 and 12. As will be more fully described herein, the tool 10 or 12 is multi-purpose in nature in that it can serve as a cultivator, a scraper, a weed puller, and serve to sever offshoots of plant life, such as suckers or branches of vines, bushes and trees and the like. As such, the tool 10 and 12 of the present invention performs the functions of a variety of different garden tools.

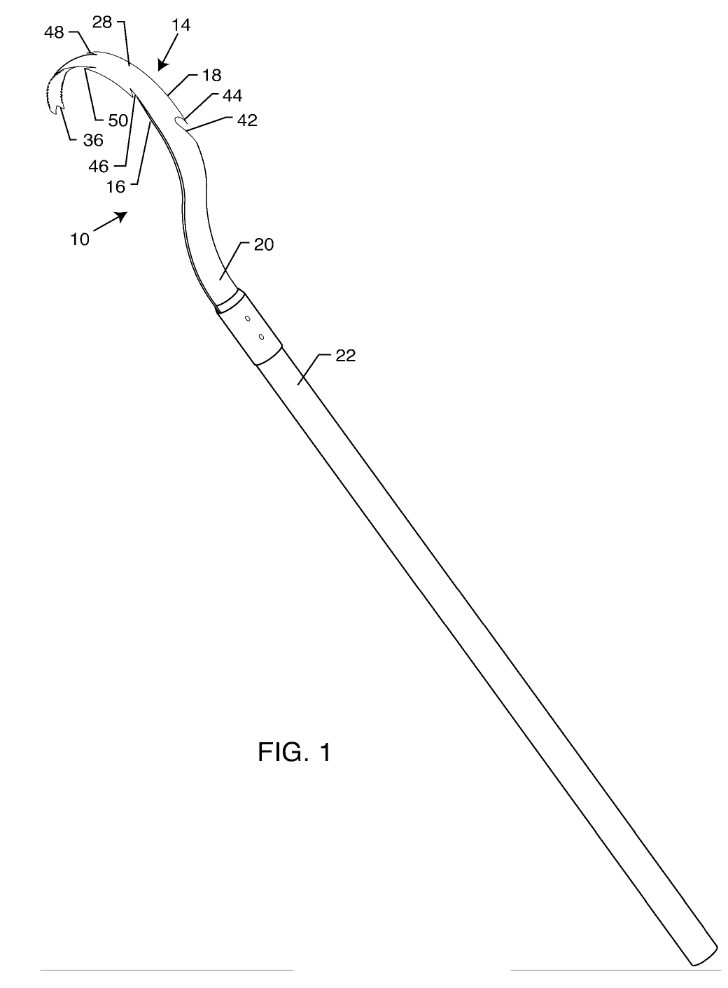

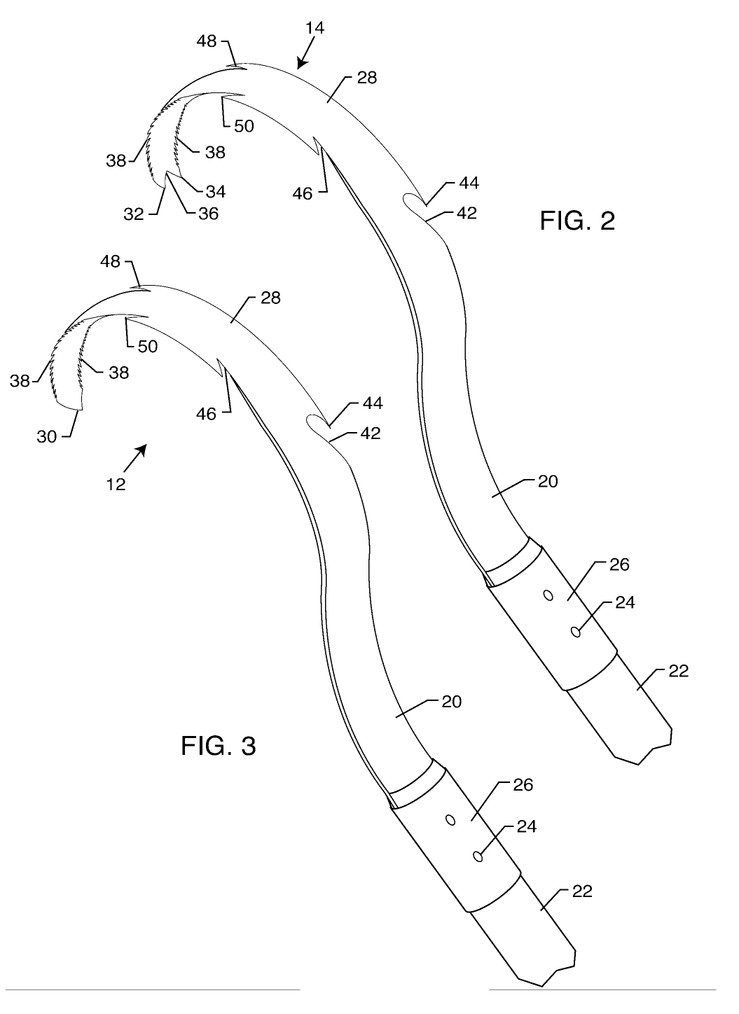

With reference now to FIGS. 1 and 2, the tool 10 is comprised of a single curved blade 14. Typically, the blade 14 is comprised of a relatively stiff and durable material, such as metal. Sheet metal, such as plate steel having a thickness of less than one-quarter inch is preferred. Typically, the thickness of the blade 14 is between one-eighth and one quarter inch, although it can be less if comprised of hardened steel or similar material. It is desirable that the blade 14 remain relatively rigid during use. The blade 14 has generally parallel first and second edges 16 and 18 so as to have a generally constant width along the significant portion thereof.

The blade 14 includes a shank portion 20 which is attachable to a handle 22. The handle 22 may be comprised of a material used for such hand-held tools, including wood, resin, plastic, etc. Typically, as illustrated in FIG. 6, the flat shank portion 20 of the blade 14 extends into the handle 22. Rivets, bolts or the like 24 extend through the shank 20 to secure it to the upper end of the handle 22. A compression sleeve 26 may also be used to fasten the blade 14 to the handle 22. It will be appreciated by those skilled in the art that other suitable means for attaching the blade 14 to the handle 22 are also possible, and contemplated by the invention. The important aspect is that the blade 14 be securely attached to a handle 22 for use by a user. The handle 22 may be relatively short so as to be used by a gardener when on his or her knees, so as to only be a foot or two in length. However, as illustrated in FIG. 1, the handle 22 may be elongated, such as five or six feet in length, so as to be used by a gardener when standing. Using the elongated handle 22 also permits the tool 10 to be extended into bushes, vines, and the like without the gardener becoming scratched by the branches, thorns, etc., of such plant life.

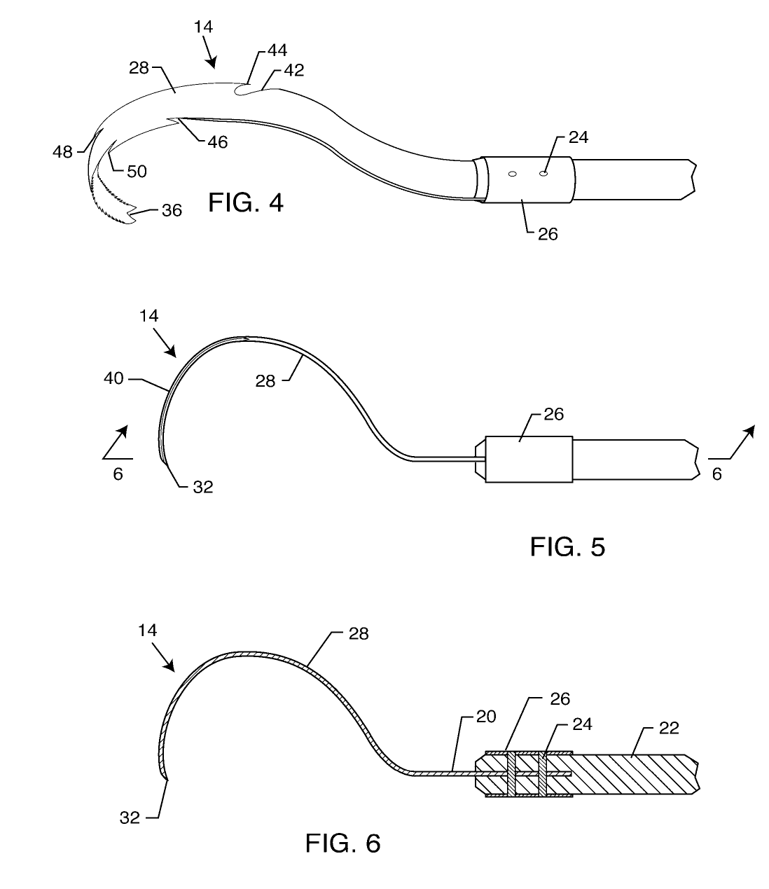

As illustrated in FIGS. 1-6, the blade 14 includes a curved portion 28 extending from the shank portion 20 away from the handle 22. The curved portion 28 is generally U-shaped or C-shaped so as to be capable of reaching around the trunk or base of a vine, bush, small tree, or branch of a larger tree so as to remove offshoots from the trunk or branch or cultivate the ground on an opposite side of the trunk or base, or remove weeds from around the trunk of base of the bush, vine, tree, etc., as will be more fully described herein.

A free end of the blade 14 is preferably tapered to form a point, so as to enable the digging and cultivating of the soil. As illustrated in FIG. 3, the free end may be tapered to a single point 30. This facilitates the entry of the blade 14 into the ground when digging and cultivating, such as when breaking up ground around a plant to remove weeds, aerate the soil, etc. In a particularly preferred embodiment, as illustrated in the remaining figures, the free end is formed into two tapered points or prongs 32 and 34 which form a V-shaped notch 36 therebetween. The edges of this notch 36 may be sharpened. A benefit of such an arrangement is that the roots of weeds caught in the notch 36 will either be severed, or more typically caught in the notch 36 and the weed pulled by its roots from the ground.

As shown in FIGS. 2 and 3, the blade 14 typically includes a series of barbs of regular or irregular nature so as to create a serrated edge 38. The phrase serrated edge is intended to refer to any type of serrated edge, that is a series of closely spaced barbs, closely spaced cuts into the blade, whether angled or not, etc. The serrated edge 38 is typically formed adjacent to the free end or tip 30 or 36. In a particularly preferred embodiment, the serrations 38 are formed on both the first and second edges 16 and 18 towards the free end of the blade 14. The serrations 38 serve several functions. The serrations 38 can be used to saw plant life. More typically, however, the serrations 38 are brought into contact with the soil and the tool 10 moved in a forward and backward scraping motion to remove grasses and small weeds, and lightly cultivate the soil. However, when the tool 10 or 12 is brought into a position wherein the tip 30 or 36 is used to dig into and cultivate the ground, the serrations 38 can further serve to break apart the dirt and uproot weeds. The serrations 38 and/or the free end 30 and 36 can be used to cultivate the ground around a plant, even a delicate plant, such as when fertilizing, as well.

There are many instances when offshoots from plant life is desirably removed. For example, in bushes, trees, etc., small twigs or branches may die. In other instances, the plant may need to be pruned, and thus the branches reduced in length. In yet other instances, offshoots, often referred to as suckers or new branches, are desirably removed. This is particularly the case in the wine industry. Grape bushes or vines often develop suckers towards a bottom thereof which sprout leaves. These require nutrients from the vine which could otherwise be diverted to the grape crop. The blade 14 of the present invention is configured to handle such tasks.

For example, the curved nature of the blade 14 enables the blade to be brought around all sides of the vine or base of the brush, etc., and one of the edges 16 or 18 used to scrape away such suckers, thorns, or other undesirable offshoots of plant life. In a particularly preferred embodiment, as illustrated in FIG. 5, at least a portion of at least one of the edges 16 and 18 is sharpened to facilitate this task. This is typically done by creating or forming a bevel at the edge to create the sharpened edge portion 40. This can be done along only a portion of a single edge 16 or 18, or along substantially the length of both side edges 16 and 18.

At least one notch 42 is formed in one of the side edges 16 or 18 of the blade 14. The notch 42 is sized so as to permit branches or twigs and the like to be received therein. Preferably, the edge of the snotch 42 is sharpened, such as by the beveling described above, so as to facilitate the cutting of the twigs, branches, etc., within the notch. In use, the gardener hooks the twig or branch to be severed within the notch 42 and pulls or tugs the tool 10 towards himself so that the branch is severed. It will also be appreciated that by those skilled in the art that the notch 42 can be used to sever large weeds and the like.

A second notch 46 may also be formed in an opposite edge 16 of the blade 14 and directed towards the handle 22 for use in a similar fashion. However, this notch 46 may be smaller and in the form of a V-shape so as to grasp and sever smaller twigs, branches, or weeds.

In a particularly preferred embodiment, one or more notches 48 and 50 are formed in one or both of the side edges 16 and 18 and directed away from the handle 22 or user. These may be U-shaped, similar to notch 42 described above, or V-shaped similar to notch 46 described above. In any event, the purposes of these notches 48 and 50 is also to sever plant life outshoots, such as twigs, branches and the like. However, due to the fact that these are directed away from the handle 22, the user catches the branch or twig, etc., within the notch 48 or 50 and pushes the handle 22 away from his or her body in order to sever the branch. These may also include sharpened edges as discussed above for the same functions. Any barb 44 may be formed at the end of each notch 42, 48 and 50. Preferably, the barbs 44 formed at the end of notches 48 and 50 are sharpened so as to facilitate digging or the like. However, the barbs 44 may also be rounded and dull, such as the barbs 44 formed at the end of notch 42, to prevent accidental injury, such as when cutting twine, branches, etc., using the sharpened edge of notch 42 and pulling the blade 14 toward one's body. As discussed above, the tool 10 and 12 of the present invention is particularly adapted for use in the wine industry, wherein suckers and other offshoots, as well as grasses and weeds surrounding the vine, can be easily removed using the tool 10. Such suckers and offshoots can be removed from the base of a vine by using either edge 16 or 18 rubbed along the trunk of the vine, or catching one of the offshoots in one of the aforementioned notches 42, or 46-50.

Although the blade 14 of the tool 10 of the present invention is particularly adapted for cultivating, scraping, removing weeds, and cutting off branches and the like, it can also be used for other gardening purposes. For example, the sharpened edge 40 or the sharpened notches 42 and 48 can be used to sever twine and the like, which can be used in the garden.

Although several embodiments have been described in detail for purposes of illustration, various modifications may be made to each without departing from the scope and spirit of the invention. Accordingly, the invention is not to be limited, except as by the appended claims.

What is claimed is:

1. A multi-purpose hand-held garden tool, comprising:
a handle;
a single curved blade having a free end connected to the handle;
a series of barbs or serrations formed on a first or second side edge of the blade adjacent to a free end thereof;
at least one notch formed in the first or second edge and generally directed towards the handle, the notch being sized and configured to sever off-shoots of plant life; and
at least one notch defining generally directed away from the handle and sized and configured to sever off-shoots of plant life.

2. The garden tool of claim 1, wherein the first and second side edges of the blade are generally parallel to one another such that the blade is of generally constant width.

3. The garden tool of claim 1, wherein the handle is between one and six feet in length.

4. The garden tool of claim 1, wherein the free end of the blade is tapered to a point.

5. The garden tool of claim 1, wherein the free end includes a notch formed therein.

6. The garden tool of claim 5, wherein the notch is generally V-shaped and defined by two prongs.

7. The garden tool of claim 5, wherein the notch includes a sharpened edge.

8. The garden tool of claim 1, wherein at least a portion of an edge of the blade is sharpened.

9. The garden tool of claim 8, wherein portions of opposite edges of the blade are sharpened.

10. The garden tool of claim 1, wherein edges defined by the notches formed in the side edges of the blade are sharpened.

11. The garden tool of claim 1, wherein an exterior end of the side edge notches define a sharp point.

12. The garden tool of claim 1, wherein the blade includes a generally straight shank portion having a free end attached to the handle, and a generally U-shaped portion distal to the handle.

13. A multi-purpose hand-held garden tool, comprising:
an elongated handle;
a single blade having a free end connected to the handle, the blade having a generally U-shaped configuration, and wherein first and second side edges of the blade are generally parallel to one another such that the blade is of generally constant width;
a free end of the blade either being tapered to a point or having a generally V-shaped notch formed therein;
a series of barbs or serrations formed on a first or second side edge of the blade adjacent to the free end of the blade;
at least one notch formed in the first or second edge and generally directed towards the handle, the notch being sized and configured to sever off-shoots of plant life; and
at least one notch defining generally directed away from the handle and sized and configured to sever off-shoots of plant life.

14. The garden tool of claim 13, wherein the handle is between one and six feet in length.

15. The garden tool of claim 13, wherein the free end notch includes a sharpened edge.

16. The garden tool of claim 13, wherein at least a portion of an edge of the blade is sharpened.

17. The garden tool of claim 16, wherein portions of opposite edges of the blade are sharpened.

18. The garden tool of claim 13, wherein edges defined by the notches formed in the side edges of the blade are sharpened.

19. The garden tool of claim 13, wherein an exterior end of the side edge notches define a sharp point.
